(19) United States
(12) Patent Application Publication
(10) Pub. No.: US 2015/0379378 A1
(43) Pub. Date: Dec. 31, 2015

(54) IMAGE FORMING APPARATUS

(71) Applicant: KYOCERA Document Solutions Inc., Osaka (JP)

(72) Inventors: Hiroshi Yokota, Osaka (JP); Seiki Satomi, Osaka (JP); Masaki Miyashita, Osaka (JP); Kunihiko Tanaka, Osaka (JP); Shinji Hayashi, Osaka (JP); Masataka Takemura, Osaka (JP)

(21) Appl. No.: 14/753,030

(22) Filed: Jun. 29, 2015

(30) Foreign Application Priority Data
Jun. 30, 2014 (JP) 2014-133790

(51) Int. Cl. G06K 15/02

(52) U.S. Cl. CPC G06K 15/027

(57) ABSTRACT

An image forming apparatus has a trial printing mode in which, when printing of a plurality of sheets of an image of a read document is requested, one sheet is printed first, the printing is interrupted once, and then the remaining sheets are printed after the interruption of the printing is released. The image forming apparatus has an image reading device, a printing unit, a judgment unit, and a control unit. The image reading device reads an image of a document. The printing unit prints an image on paper. The judgment unit judges whether or not an image read by the image reading device is outside an image formation region of paper to be printed by the printing unit. When the judgment unit judges that the image is outside the image formation region of the paper, the control unit controls the image forming apparatus to enter the trial printing mode.

### INCORPORATION BY REFERENCE

The disclosure of Japanese Patent Application No. 2014-133790 filed on Jun. 30, 2014 including the specification, drawings and abstract is incorporated herein by reference in its entirety.

### BACKGROUND

The disclosure relates to an image forming apparatus and particularly relates to an image forming apparatus which prints a formed image on paper.

In an image forming apparatus typified by a digital multifunctional peripheral and the like, an image of a document is read by an image reading device, and then an electrostatic latent image is formed on a photoconductor provided in an image forming unit based on the read image. Then, a developing agent, such as charged toner, is supplied onto the formed electrostatic latent image to form a visible image, the image is transferred and fixed to paper, and then the paper is discharged out of the image forming apparatus. Thus, duplication of an image of a document, i.e., copying, is performed. In copying, the number of sheets to be printed is set to a plurality of sheets in many cases.

Herein, when the image forming apparatus performs copying, trial copying is performed in some cases. In the trial copying, when a plurality of sheets are copied, one sheet is printed first, the printing is interrupted once, and then the remaining sheets are printed after the interruption of the printing is released. When such a trial copying function is utilized, a user can check the contents of the printing using printed matter obtained by the first printing of one sheet, which can prevent printing of a large number of sheets which is not desired by a user. Techniques relating to the trial copying have been known heretofore.

A typical image forming apparatus is known in which a trial copying range can be specified in the trial copying and the trial copying is performed while selecting the smallest paper size as possible from the viewpoint of saving toner and paper. The typical image forming apparatus narrows and skips a character portion of a displayed image in the trial copying from the viewpoint of saving toner and paper. Furthermore, a plurality of images are image-processed as one image by reducing the size of a photograph portion or reducing the size of the entire image.

### SUMMARY

In a first aspect of the disclosure, an image forming apparatus has a trial printing mode in which, when printing of a plurality of sheets of an image of a read document is requested, one sheet is printed first, the printing is interrupted once, and then the remaining sheets are printed after the interruption of the printing is released. The image forming apparatus has an image reading device, a printing unit, a judgment unit, and a control unit. The image reading device reads an image of a document. The printing unit prints an image on paper based on an image read by the image reading device. The judgment unit judges whether or not the image read by the image reading device is outside an image formation region of the paper to be printed by the printing unit. When the judgment unit judges that the image read by the image reading device is outside the image formation region of the paper to be printed by the printing unit, the control unit controls the image forming apparatus to enter the trial printing mode.

### BRIEF DESCRIPTION OF THE DRAWINGS

FIG. 1 is a schematic perspective view illustrating the appearance of a digital multifunctional peripheral when an image forming apparatus according to one embodiment of the disclosure is applied to the digital multifunctional peripheral and illustrates the state where a document cover is opened.

FIG. 2 is a schematic perspective view illustrating the appearance of the digital multifunctional peripheral when the image forming apparatus according to one embodiment of the disclosure is applied to the digital multifunctional peripheral and illustrates the state where the document cover is closed.

FIG. 3 is a block view illustrating the configuration of the digital multifunctional peripheral when the image forming apparatus according to one embodiment of the disclosure is applied to the digital multifunctional peripheral.

FIG. 4 is an outline view illustrating the schematic configuration of an operation unit.

FIG. 5 is a schematic view when a part of an image reading device is viewed from above.

FIG. 6 is a flow chart showing the flow of processing when copying an image read by the image reading device and showing the case of judging whether or not the read image is outside an image formation region of paper to be printed by a printing unit.

FIG. 7 is a view illustrating an example of a document placed on a platen.

FIG. 8 is a view illustrating printed matter obtained by performing trial copying.

FIG. 9 is a view illustrating an example of a display screen when inquiring whether or not printing is continued.

FIG. 10 is a view illustrating an A4 size document on which an image of a hatched circle region is shown.

FIG. 11 is a view illustrating an example of printed matter when the document illustrated in FIG. 10 is enlarged and copied.

FIG. 12 is a flow chart showing the flow of processing when copying an image read by an image reading device and showing the case of judging whether or not an end portion of the image inclines.

FIG. 13 is a view illustrating an example of a book document placed on a platen.

### DETAILED DESCRIPTION

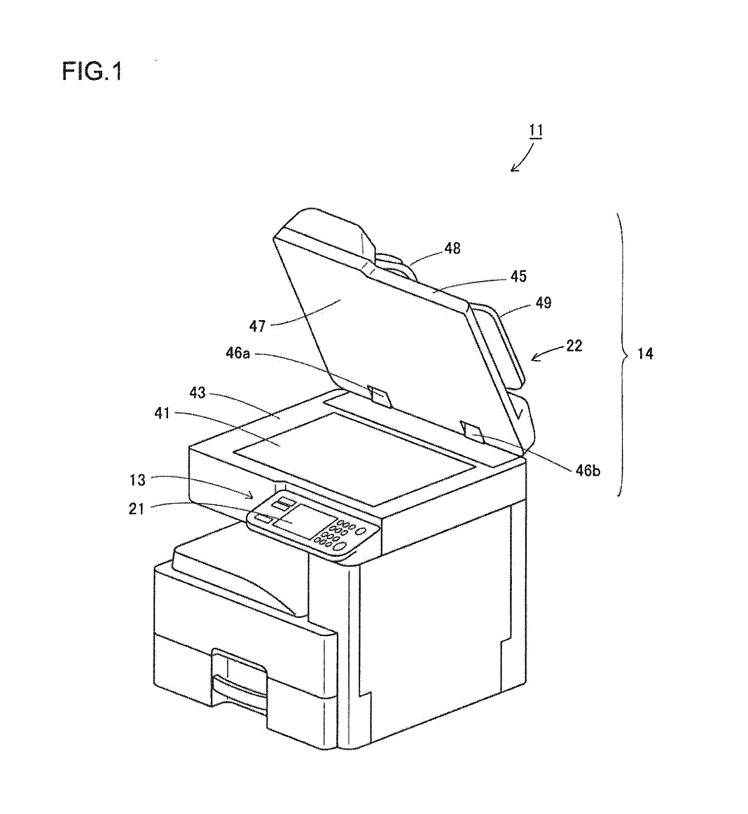

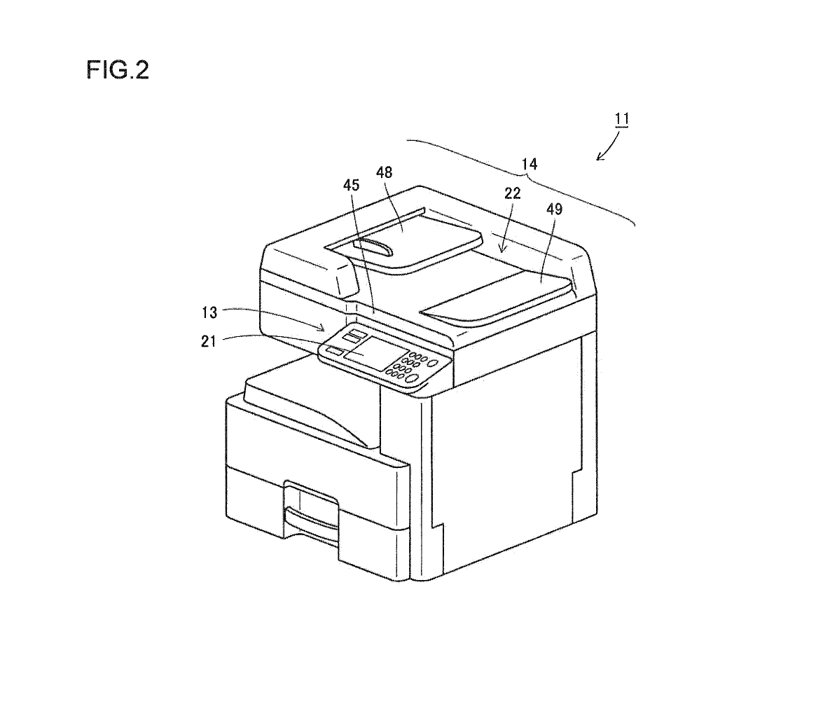

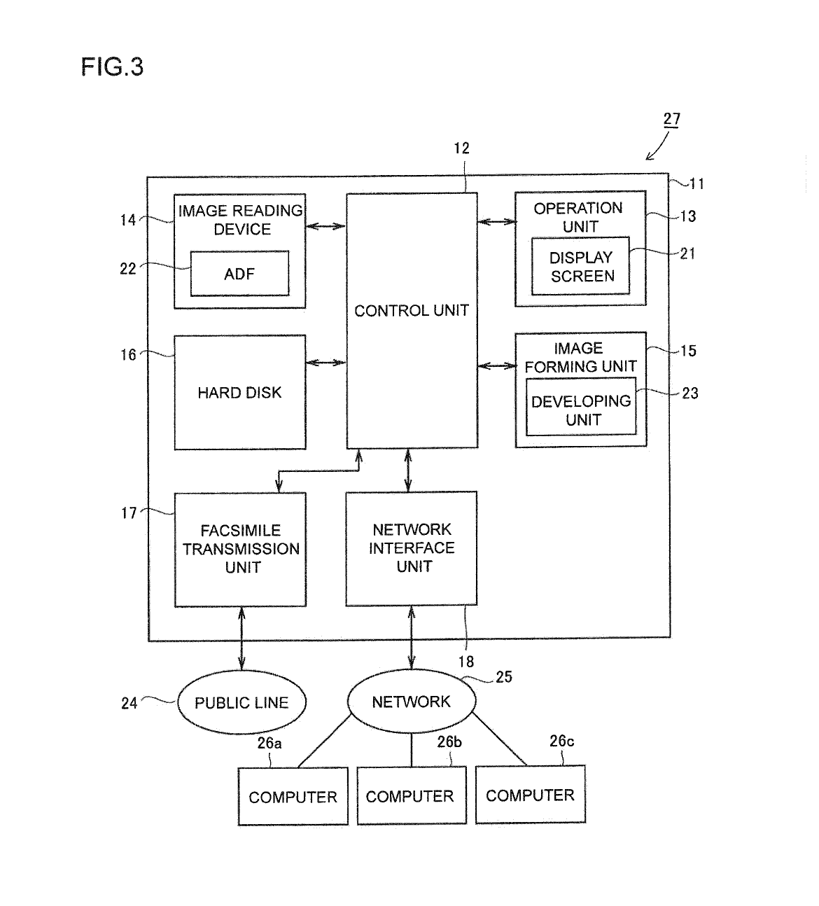

Hereinafter, an embodiment of the disclosure is described. First, the configuration of an image forming apparatus according to one embodiment of the disclosure is described. FIG. 1 and FIG. 2 are schematic perspective views illustrating the appearance of a digital multifunctional peripheral when the image forming apparatus according to one embodiment of the disclosure is applied to the digital multifunctional peripheral. FIG. 1 illustrates a state where a document cover described later is opened. FIG. 2 illustrates a state where the document cover is closed. In the states illustrated in FIG. 1 and FIG. 2, the side on which an operation unit described later is disposed is the front side of the digital multifunctional peripheral and the opposite side, i.e. the side on which the document cover is attached to the apparatus body, is the rear side of the digital multifunctional peripheral. FIG. 3 is a block view illustrating the configuration of the digital multifunctional peripheral when the image forming apparatus according to one embodiment of the disclosure is applied to the digital multifunctional peripheral.

With reference to FIG. 1 to FIG. 3, a digital multifunctional peripheral 11 as the image forming apparatus according to one embodiment of the disclosure has a control unit 12 which controls the entire digital multifunctional peripheral 11, an operation unit 13 which includes a display screen 21 which displays information sent from the digital multifunctional peripheral 11 and input contents from users and which inputs the image formation conditions, such as the number of print copies and the gradation, and turns ON/OFF the power supply, an image reading device 14 which includes an auto document feeder (ADF) 22 which automatically feeds a set document to a reading unit and reads an image of the document, an image forming unit 15 which includes a developing unit 23 which performs development using toner and forms an image based on a read image and image data transmitted through a network 25, a hard disk 16 which stores the transmitted image data, the input image formation conditions, and the like, and a facsimile communication unit 17 which is connected to a public line 24 and performs facsimile transmission and facsimile reception, and a network interface unit 18 for connection with the network 25. Although the digital multifunctional peripheral 11 has a dynamic random access memory (DRAM) which writes and reads image data and a paper feeder which feeds paper to which the visualized image formed with a developing agent is transferred, and the like, an illustration and a description thereof is omitted. The arrows in FIG. 3 indicate the flow of control signals and data relating to control and images.

The digital multifunctional peripheral 11 operates as a copying machine by forming an image in the image forming unit 15 using a document read by the image reading device 14, and then printing the image on paper. Moreover, the digital multifunctional peripheral 11 operates as a printer by forming an image in the image forming unit 15 using image data transmitted from computers 26a, 26b, and 26c connected to the network 25 through the network interface unit 18, and then printing the image on paper. More specifically, the image forming unit 15 operates as a printing unit which prints a requested image. Moreover, the digital multifunctional peripheral 11 operates as a facsimile machine by forming an image in the image forming unit 15 through the DRAM using image data transmitted from the public line 24 through the facsimile communication unit 17 and by transmitting image data of a document read by the image reading device 14 to the public line 24 through the facsimile communication unit 17. More specifically, the digital multifunctional peripheral 11 has a plurality of functions relating to image processing, such as a copying function, a printer function, and a facsimile function. The digital multifunctional peripheral 11 further has a function which allows detail setting of each function.

The digital multifunctional peripheral 11 has a trial copying mode as a trial printing mode. In the trial copying mode, the image reading device 14 is used and, when it is requested to print a plurality of sheets of an image of a read document, one sheet is printed first, the printing is interrupted once, and then the remaining number of sheets are printed after the interruption of the printing is released.

An image forming system 27 including the digital multifunctional peripheral 11 has the digital multifunctional peripheral 11 and the plurality of computers 26a, 26b, and 26c. Specifically, the image forming system 27 has the digital multifunctional peripheral 11 of the configuration described above and the plurality of computers 26a, 26b, and 26c connected to the digital multifunctional peripheral 11 through the network 25. In this embodiment, three computers are illustrated as the plurality of computers 26a to 26c. The computers 26a to 26c each can perform printing by performing a printing request to the digital multifunctional peripheral 11 through the network 25. The digital multifunctional peripheral 11 and the computers 26a to 26c may be connected through a cable using a local area network (LAN) cable or the like or may be wirelessly connected. It may be configured so that another digital multifunctional peripheral and a server may be connected in the network 25.

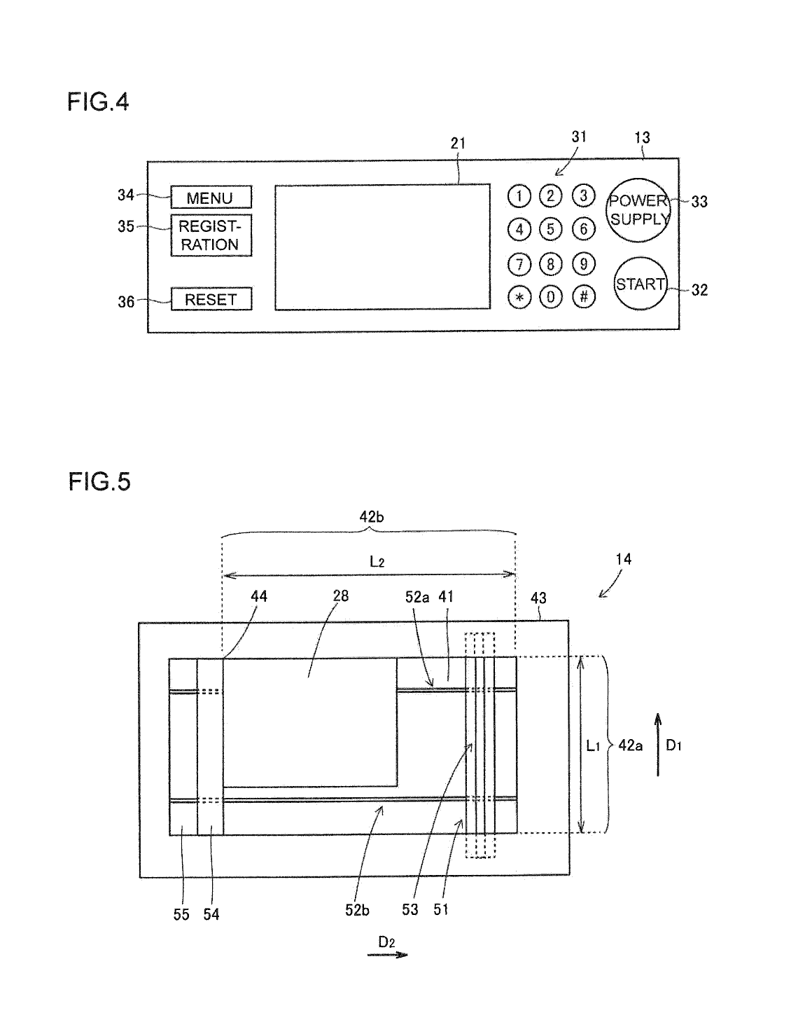

Next, the configuration of the above-described operation unit 13 is described in more detail. FIG. 4 is an outline view illustrating a schematic configuration of the operation unit 13. With reference to FIG. 1 to FIG. 4, the operation unit 13 has a ten key 31 for inputting the number to 0 to 9 for inputting the number of print copies and the like and the symbols of “*” and “#”, a start key 32 which instructs the start of printing and the start of facsimile transmission, a power supply key 33 which turns ON/OFF the power supply of the digital multifunctional peripheral 11, a menu key 34 which instructs the selection of the printer function, the copying function, and the like of the digital multifunctional peripheral 11, a registration key 35 which instructs the registration of various image formation conditions and a user, a reset key 36 which cancels the contents of an instruction input by a user using the ten key 31 and the like, and the above-described display screen 21. The display screen 21 has a liquid crystal touch panel function, which allows input of the image formation conditions and the like, the selection of the functions, and the like also from the display screen 21 by pressing the display screen 21 with a user's finger and the like.

Next, the configuration of the image reading device 14 described above is described in more detail. FIG. 5 is a schematic view of a part of the image reading device 14 as viewed from above. In FIG. 5, the ADF 22 and hinges described later are mainly omitted from the viewpoint of ease of understanding. An arrow D₁ in FIG. 5 or the opposite direction is the main scanning direction. The arrow D₁ is a direction from the front side of the apparatus toward the rear side of the apparatus. An arrow D₂ in FIG. 5 or the opposite direction is the subscanning direction. In an embodiment illustrated in FIG. 5, a rectangular document 28 placed in a platen described later is placed in such a manner that the subscanning direction is the longitudinal direction and the edge of the document in the subscanning direction, i.e., an end portion of the document 28, extends straight in the main scanning direction. More specifically, in FIG. 5, the document 28 is placed straight without inclining.

With reference to FIG. 1 to FIG. 5, the image reading device 14 has a platen 41 on which the document 28, from which an image is read, is placed. The platen 41 is configured from a transparent plate material, such as contact glass, and allows transmission of light emitted from a lower region of the platen 41, so that the light irradiates the document 28 placed on the platen 41. The platen 41 has a size which allows reading of the entire surface of a document, even when a so-called A3 size document is placed on the platen 41, and allows reading of the document 28 placed on the platen 41 in the range of a region 42a indicated by a length L1 in the main scanning direction of the platen 41 and a region 42b indicated by a length L2 in the subscanning direction of the platen 41. The platen 41 is attached to the image reading device 14 in such a manner as to be inserted into a case 43 configuring the rough framework of the image reading device 14. The document 28 is usually placed in such a manner that the corner of the document 28 is placed on a set position 44 positioned in the upper left corner of the platen 41 as viewed from above illustrated in FIG. 5, specifically on a corner portion on the rear side of the platen 41 and on the side on which a light shielding unit described later is disposed.

The image reading device 14 has a document cover 45 which can open and close the upper surface of the platen 41 and presses the document 28 placed on the platen 41. As described above, FIG. 1 illustrates the state where the document cover 45 is opened and the state illustrated in FIG. 2 is the state where the document cover 45 is closed. The document cover 45 is attached to the case 43 with a pair of hinges 46a and 46b. The document cover 45 can be opened by lifting upward the front side of the document cover 45. A rear surface 47 of the document cover 45 facing the platen 41 in the state where the document cover 45 is closed is configured from a flat and white member. The document cover 45 also configures a part of the configuration of the ADF 22. When briefly described, the ADF 22 has the document cover 45 facing the platen 41 in the closed state, a paper feed tray 48 which sets two or more of the documents 28, a plurality rollers (not illustrated), such as a pickup roller, for feeding the documents 28, a paper discharging tray 49 which discharges the plurality of documents 28, images of which are completely read, and the like. In the ADF 22, the plurality of documents 28 are set on the paper feed tray 48 provided on the upper side of the document cover 45 in the state where the document cover 45 is closed. The ADF 22 successively feeds the set plurality of documents 28 to the platen 41 side when detecting pressing down of the start key 32 of the operation unit 13. Then, the ADF 22 discharges the plurality of documents 28 to the paper discharging tray 49 after successively reading images of the plurality of documents 28 by a carriage described later. The ADF 22 is effectively used when a plurality of documents are to be read. Although not illustrated, the image reading device 14 includes a document cover opening-and-closing detection unit which detects opening and closing of the document cover 45.

The image reading device 14 has a carriage 51 which is disposed in a lower region of the platen 41 and is movable along the platen 41. In this case, the carriage 51 is movable in the subscanning direction indicated by the arrow D₂ or in the opposite direction in the lower region of the platen 41. Specifically, the carriage 51 is configured to be movable in the subscanning direction in the range where the platen 41, a light shielding unit described later, and an ADF-fed-document reading unit similarly described later are positioned. When the carriage 51 reads an image of the document 28 placed on the platen 41, the carriage 51 reads the image of the document 28 placed on the platen 41 while moving in the direction indicated by the arrow D₂ from the set position 44, at which the reading starts, as the starting point. The carriage 51 moves in the direction opposite to the direction indicated by the arrow D₂ after finishing the reading of the images of the documents 28, and then returns to the position at which the reading of the documents 28 starts. In the lower region of the platen 41, two metal sticks 52a and 52b each having a shape extending in the subscanning direction are provided in parallel to each other with an interval. The carriage 51 is guided by the two metal sticks 52a and 52b in movement.

The carriage 51 has an exposure lamp 53 which emits light upward from the lower region of the platen 41, a plurality of mirrors (not illustrated), a lens (not illustrated) which condenses light, and a charge coupled device (CCD) sensor (not illustrated) as an image sensor. The exposure lamp 53 is configured by disposing a plurality of so-called light emitting diodes (LEDs) in the main scanning direction. The exposure lamp 53 is provided over the entire region in the main scanning direction of the carriage 51. The carriage 51 emits light to the platen 41 from the exposure lamp 53 while moving in the subscanning direction, when reading the image of the document 28. Then, reflected light reflected from the platen 41 side, specifically from the document 28 placed on the platen 41, is condensed by the plurality of mirrors and the lens, and then input into the CCD sensor, whereby the image of the document 28 placed on the platen 41 is read.

The image reading device 14 has a light shielding unit 54 which shields the light from the exposure lamp 53. The light shielding unit 54 is provided at a position where in such a manner that the light shielding unit 54 and the platen 14 are provided side by side. The light shielding unit 54 and the platen 41 are adjacent to each other. The light shielding unit 54 is configured from a resin member which is not a so-called transparent member but is a white member. The light shielding unit 54 is a long and narrow plate member extending in the main scanning direction. The length in the main scanning direction of the light shielding unit 54 is the same as the length in the main scanning direction of the platen 41. Shielding compensation and the like of the exposure lamp 53 are performed using the light shielding unit 54.

Moreover, the image reading device 14 has an ADF-fed-document reading unit 55. The ADF-fed-document reading unit 55 is provided at a position opposite to the platen 41 in the subscanning direction with respect to the light shielding unit 54. The ADF-fed-document reading unit 55 is provided adjacent to the light shielding unit 54. The ADF-fed-document reading unit 55 has a thin plate shape and is configured from a transparent member, such as glass. The ADF-fed-document reading unit 55 is provided in the movable range of the carriage 51. More specifically, the ADF-fed-document reading unit 55 is provided at a position where reading can be performed by the carriage 51. The ADF 22 successively feeds the plurality of documents 28 to the position where the ADF-fed-document reading unit 55 is provided. Images of the fed documents 28 are read by the carriage 51 at the position where the ADF-fed-document reading unit 55 is provided. In this case, the carriage 51 reads the images of the documents 28 fed by the ADF 22 in the state where the carriage 51 is held at the position where the ADF-fed-document reading unit 55 is provided in the subscanning direction. More specifically, with respect to the images of the documents 28 fed by the ADF 22, the images of the documents 28 are read by holding the carriage 51 at the position where the ADF-fed-document reading unit 55 is provided, and then feeding the document.

Next, the case of copying an image read by the image reading device 14 using the digital multifunctional peripheral 11 according to one embodiment of the disclosure is described. In this case, it is supposed that the size of the paper to be printed is set to the A4 size. As the document, one of unspecified size which is longer and narrower than A4 size paper is used.

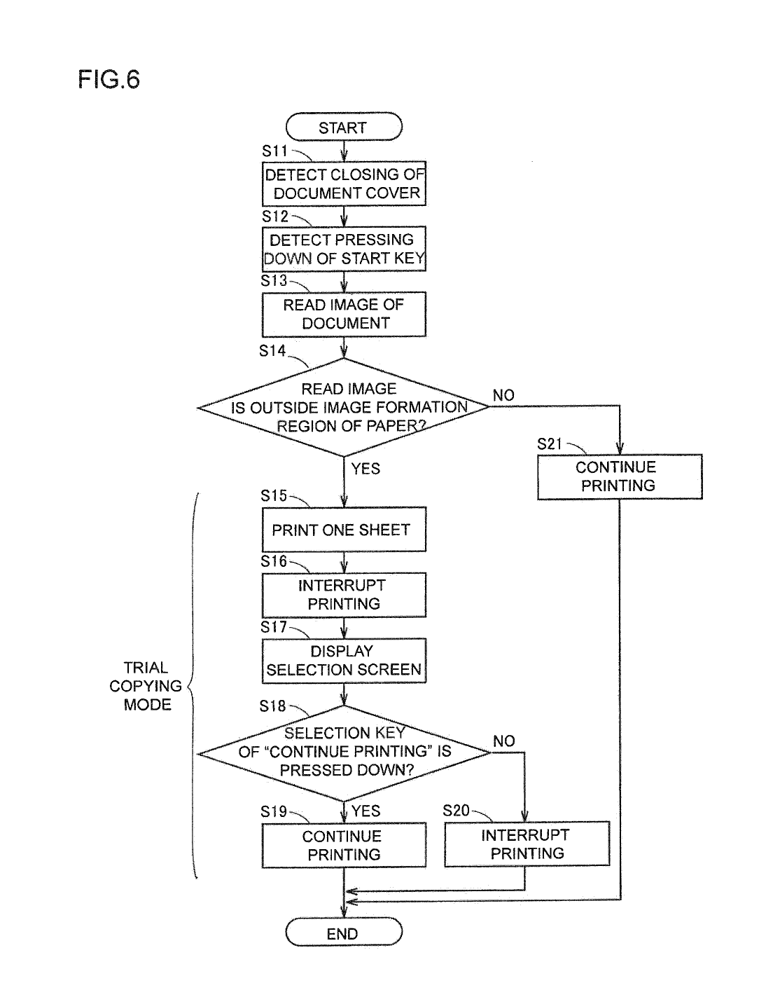

FIG. 6 is a flow chart showing the flow of processing of copying the image read by image reading device using the digital multifunctional peripheral 11 according to one embodiment of the disclosure. With reference to FIG. 6, etc., a user places a document on the platen 41 which is a placement table, and then closes the document cover 45. Then, a user sets a copying mode utilizing the touch panel function, the ten key 31, and the like of the display screen 21 of the operation unit 13, sets the size of paper to be printed to the A4 size, and then inputs the number of print copies, e,g., ten sheets, and the like. Then, a user presses down the start key 32 for copying. When the digital multifunctional peripheral 11 detects that the document cover 45 is closed (Step S11 in FIG. 6, Hereinafter, “Step” is omitted.), and then detects that the start key 32 for copying is pressed down (S12), an image of the document on the platen 41 is read by the image reading device 14 (S13). In this case, the carriage 51 described above is moved in the subscanning direction indicated by the arrow D₂, and then the image of the document is scanned.

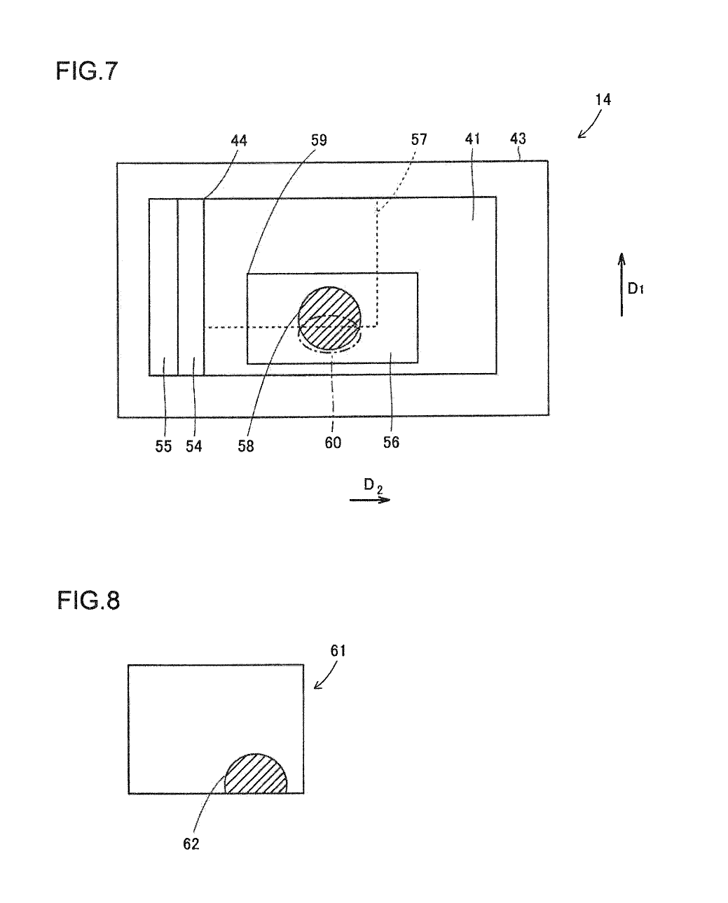

FIG. 7 is a view illustrating an example of a document 56 placed on the platen 41. In FIG. 7, an illustration of the carriage 51 and the like is omitted from the viewpoint of ease of understanding. A region 57 of A4 size paper when set to the set position 44 is indicated by the dotted lines.

With reference to FIG. 7, the size of the document 56 of unspecified size is laterally longer than the A4 size paper of unspecified size. Specifically, the document 56 of unspecified size is configured to be shorter in the main scanning direction and to be longer in the subscanning direction relative to the A4 size document. In the center of the document 56, an image 58 of a hatched circle region of FIG. 7 is shown. From the viewpoint of ease of understanding, FIG. 7 is illustrated in such a manner that the image 58 can be seen from the rear side of the document 56. The document 56 is placed to be largely shifted from the original document set position 44. Specifically, the document 56 is placed in such a manner that an upper left corner portion 59 of the document 56 of unspecified size is not set to the document set position 44 at the upper left corner portion of the platen 41 and the upper left corner portion 59 of the document 56 is placed closer to the center side of the platen 41. In this case, in a region 60 indicated by the alternate long and short dash lines, a part of the image 58 projects from the region of the A4 size paper. More specifically, a part of the image 58 is outside the image formation region of the paper.

Next, the digital multifunctional peripheral 11 judges whether or not a read image is outside the image formation region of the paper to be printed, i.e., the image 58 of the document 56 read by the image reading device 14 is present outside the image formation region of the paper to be printed (S14). Herein, the control unit 12 operates as a judgment unit.

In this case, specifically, the control unit 12 as a judgment unit counts the number of dots other than white dots in each of the lines extending in the main scanning direction and positioned side by side in the subscanning direction in a region outside the image formation region of the paper to be printed by the image forming unit 15 among the images read by the image reading device 14. Then, when there is a region where the number of the counted dots exceeds the predetermined value, the control unit 12 judges that the image is outside the image formation region of the paper.

When it is judged that the read image is outside the region of the paper to be printed (YES in S14), the image is printed in the trial copying mode. In this case, one A4 size paper on which a part of the image 58 of a hatched circle region is not formed is printed (S15). FIG. 8 is a view illustrating printed matter obtained by the trial copying. With reference to FIG. 8, on the printed matter 61 obtained by printing one sheet, an image 62 in which a part of the original image 58 of the document 56 is not, is formed.

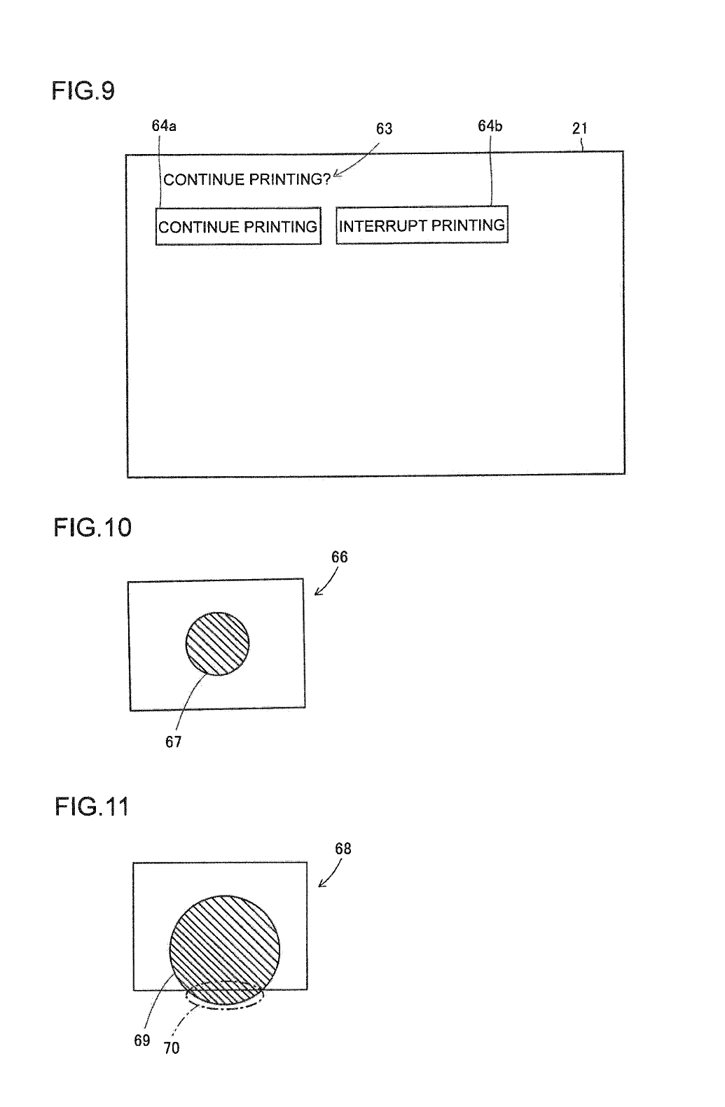

Then, the digital multifunctional peripheral 11 does not perform printing of the remaining nine sheets, and then interrupts the printing (S16). Then, the digital multifunctional peripheral 11 displays a screen of inquiring whether or not the printing is continued (S17). More specifically, the digital multifunctional peripheral 11 waits for the release of the interruption of the printing, and then inquires of a user whether or not the interruption of the printing is released. FIG. 9 is a view illustrating an example of the display screen 21 in the case of inquiring of a user whether or not the printing is continued. With reference to FIG. 9, a message 63 of an inquiry of “Continue printing?”, a selection key 64a of “Continue printing”, and a selection key 64b of “Interrupt printing” are displayed on the display screen 21 having the touch panel function in S17.

A user sees the printed matter 61 obtained by printing one sheet to check the printed contents. When the printed matter 61 illustrated in FIG. 8 is one requested by a user, the user continues the printing. More specifically, the user releases the interruption of the printing.

In this case, the user presses down the selection key 64a of “Continue printing”. The digital multifunctional peripheral 11 detects the pressing down of the selection key 64a of “Continue printing” (YES in S18), the remaining printing is continuously performed supposing that the interruption of the printing is released (S19). More specifically, the digital multifunctional peripheral 11 continues the printing of the remaining nine sheets to end the processing. On the other hand, when a user checks the printed matter 61 to find out that the printed matter 61 is not one requested by the user, the user presses down the selection key 64b of “Interrupt printing”. When the digital multifunctional peripheral 11 detects the pressing down of the selection key 64b of “Interrupt printing” (NO in S18), the digital multifunctional peripheral 11 interrupts the printing without performing the printing of the remaining nine sheets (S20), and then ends the processing. In this case, in the digital multifunctional peripheral 11, the job spooled in the print job is eliminated, and then the processing is ended. When it is judged that no image is outside the image formation region of paper in S14 (NO in S14), the digital multifunctional peripheral 11 does not enter the trial copying mode, and then continues the printing of the ten sheets (S21) to end the processing.

According to such the digital multifunctional peripheral 11, when it is judged whether or not the image read by the image reading device 14 is outside the image formation region of the paper to be printed by the image forming unit 15, and then it is judged that the image read by the image reading device 14 is outside the image formation region of the paper printed by the image forming unit 15, the digital multifunctional peripheral 11 enters the trial printing mode. Therefore, when there is a possibility that a large number of sheets of the image, which is not desired by a user, are to be printed, the check of the printed matter by a user can be promoted. In this case, a user does not need to intentionally set the trial printing mode. Therefore, such the digital multifunctional peripheral 11 can improve the convenience of a user and can efficiently perform printing desired by a user.

In this case, the control unit 12 counts the number of dots other than white dots in each of lines extending in the main scanning direction and positioned side by side in the subscanning direction in a region outside the image formation region of the paper to be printed by the image forming unit 15 among the images read by the image reading device 14. Then, when there is a region where the number of the counted dots exceeds the predetermined value, the control unit 12 judges that the image is outside the image formation region of the paper. Therefore, it can be more certainly judged whether or not an image is outside the image formation region of paper.

When forming an image using a read image, image processing of the read image is performed in some cases. For example, a case of enlarging and printing a read image and a case of performing printing by performing image processing in such a manner as to move a part of the read image are mentioned. Also in such a case, it may be configured so that it is judged whether not the image formed by performing image processing is outside the image formation region of paper, and then the digital multifunctional peripheral 11 enters the copying mode according to the judgment result. Specifically, in the case of a usual image output, i.e., not performing image processing, the image is not outside the image formation region of paper. However, in the case of enlarging an image, it is configured so that when it is judged that the enlarged image is outside the image formation region of paper, the digital multifunctional peripheral 11 enters the trial copying mode. For example, when an A4 size document 66 on which an image 67 of a hatched circle region is shown as illustrated in FIG. 10 is used and the image 67 is enlarged about several times and copied, a partial region 70 of an image 69 to be formed is outside the image formation region of paper in A4 size printed matter 68 as illustrated in FIG. 11. The digital multifunctional peripheral 11 is applied also to the case where performing such image processing and copying a plurality of sheets.

In the embodiment described above, when the printing is interrupted, a message of “Correctly place document” may be displayed on the display screen 21. The displaying of such a message suggests to a user to place the document in such a manner that the read image is within the image formation region of paper, and can promote the correct placement of the document.

In the embodiment described above, it is configured so that it is judged whether or not the read image is outside the image formation region of paper. However, the configuration is not limited thereto and it may be configured so that when it is judged that an end portion of the read document inclines, the digital multifunctional peripheral 11 enters the trial copying mode.

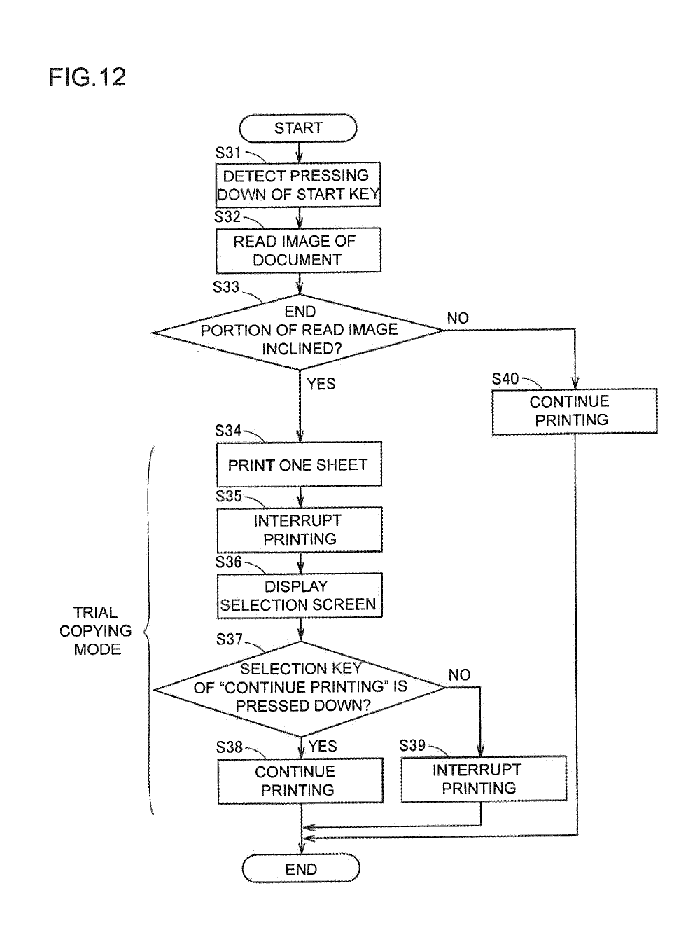

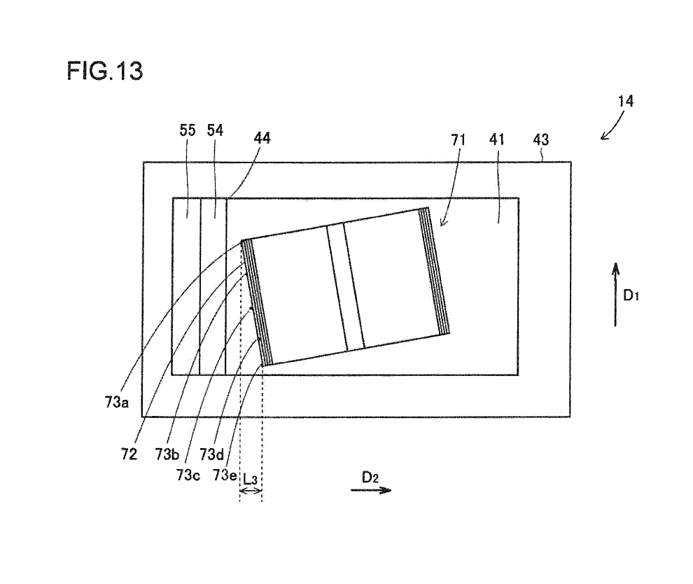

FIG. 12 is a flow chart showing the flow of processing in this case. FIG. 12 corresponds to FIG. 6. FIG. 13 is a view illustrating an example of a book document 71 placed on the platen 41. FIG. 13 corresponds to FIG. 7. With reference to FIG. 13, the book document 71 which is an opened thick book is placed on the platen 41. More specifically, a user attempts to copy a plurality of sheets of two facing pages of the book document 71. In such a case, the copying is performed without closing the document cover 45.

Herein, the book document 71 is placed in an inclined state. More specifically, the book document 71 is placed in such a manner that an end portion 72 of the book document 71 is placed in an inclined state with respect to the main scanning direction. Also in FIG. 13, an illustration of the carriage 51 and the like is omitted similarly to FIG. 7 from the viewpoint of ease of understanding.

With reference to FIG. 12 and FIG. 13, when the pressing down of the start key 32 for copying is detected (S31), the image of the document on the platen 41 is read by the image reading device 14. More specifically, the carriage 51 described above is moved in the subscanning direction indicated by the arrow D₂ to scan the image of the book document 71 (S32).

Next, the digital multifunctional peripheral 11 judges whether or not an end portion of the image read by the image reading device 14 inclines (S33). Herein, the control unit 12 operates as a judgment unit.

In this case, when a plurality of coordinate positions of changing points at which the color changes from white to black in the subscanning direction are detected with respect to the end portion of the image read by the image reading device 14, and then a difference between the adjacent coordinate positions in the subscanning direction among the plurality of detected coordinates positions exceeds a certain value, it is judged that the end portion of the image inclines. When specifically described, the coordinate position of a changing point 73a closest to the set position 44 at which the color changes from white to black in the subscanning direction is first detected in an end portion of the image corresponding to an end portion 72 of the book document 71 in the subscanning direction. Next, the coordinate position of a changing point 73b next closest to the set position 44 with a predetermined interval is detected. A difference in the subscanning direction of the coordinate positions of the changing points 73a and 73b is calculated. It is judged whether or not the calculated difference extends a certain value. The detection of the difference is performed using the changing points 73c, 73d, and 73e positioned with predetermined intervals in the order closer to the set position 44. Then, it is similarly judged whether or not the difference exceeds a certain value.

When it is judged that the end portion of the read image inclines (YES in S33), printing is performed in the trial copying mode. In this case, specifically, one sheet of the image, whose end portion inclines, of the document is printed (S34). Then, the printing is interrupted without performing the printing of the remaining nine sheets (S35). Then, a screen of inquiring whether or not the printing is continued illustrated in FIG. 9 is displayed (S36). The digital multifunctional peripheral 11 detects the pressing down of the selection key 64a of “Continue printing” (YES in S37), the remaining printing is continuously performed supposing that the interruption of the printing is released (S38). More specifically, the digital multifunctional peripheral 11 continues the printing of the remaining nine sheets to end the processing. On the other hand, when the digital multifunctional peripheral 11 detects the pressing down of the selection key 64b of “Interrupt printing” (NO in S37), the digital multifunctional peripheral 11 interrupts the printing without performing the printing of the remaining nine sheets (S39) to end the processing. When it is judged that the end portion of the image does not incline in S33 (NO in S33), the digital multifunctional peripheral 11 does not enter the trial copying mode, and then continues the printing of the ten sheets (S40) to end the processing.

According to such the digital multifunctional peripheral 11, when it is judged whether or not the end portion of the image read by the image reading device 14 inclines, and it is judged that the end portion of the image read by the image reading device 14 inclines, the digital multifunctional peripheral 11 enters the trial copying mode. Therefore, when a possibility that a large number of sheets of the image which is not desired by a user are printed is high, the check of the printed matter by a user can be promoted. In this case, a user does not need to intentionally set the trial printing mode. Particularly in this case, there is no necessity of setting the trail copying mode for each page when copying the book document. Therefore, such the digital multifunctional peripheral 11 can improve the convenience of a user and can efficiently perform printing desired by a user. Also in this case, when the printing is interrupted, a message of “Correctly place document” may be displayed on the display screen 21.

In the embodiment described above, it is configured so that, when reading the image of the book document placed on the platen, it is judged whether or not the end portion of the read image inclines. However, the configuration is not limited thereto, and it may be configured so that, in the case of automatically feeding a document to the ADF-fed-document reading unit using the ADF, and then reading an image of the document, it is judged whether or not the end portion of the image of the read document inclines, and then the digital multifunctional peripheral 11 enters the trial copying mode. More specifically, it may be configured so that, when it is detected that the document to be read is fed in an inclined state by the ADF, the digital multifunctional peripheral 11 enters the trial copying mode, for example.

In the embodiment described above, it may be configured so that it is judged whether or not an end portion of not only the book document but a usual one-sheet document placed on the platen inclines, and then the digital multifunctional peripheral 11 enters the trial copying mode according to the judgment result.

The embodiment above describes the case where copying is performed but is not limited thereto and can be applied also to a case of performing printing using the printer function, i.e., a case of performing trial printing, for example.

In the embodiment above, it may be configured so that it is judged whether or not a read image is outside the image formation region of paper, it is judged whether or not an end portion of the image inclines, and then it is determined whether or not the digital multifunctional peripheral 11 enters the trial copying mode. On the contrary, it may be configured so that it is judged whether or not an end portion of an image inclines, it is judged whether or not a read image is outside the image formation region of paper, and then it is determined whether or not the digital multifunctional peripheral 11 enters the trial copying mode.

The embodiment and examples disclosed in this specification are merely examples in all the respects and it should be understood that the embodiment and examples are not restrictive in all the aspects. It should be construed that the range of the present disclosure is prescribed not by the description above but by Claims and all alternations within a meaning or range equivalent to claims are included.

The image forming apparatus according to the disclosure is particularly effectively used when a reduction of an unnecessary copy is required.

What is claimed is:

1. An image forming apparatus having a trial printing mode in which, when printing of a plurality of sheets of an image of a read document is requested, one sheet is printed first, the printing is interrupted once, and then remaining sheets are printed after the interruption of the printing is released, the image forming apparatus comprising:
an image reading device which reads an image of a document;
a printing unit which prints an image on paper based on an image read by the image reading device;
a judgment unit which judges whether or not the image read by the image reading device is outside an image formation region of paper to be printed by the printing unit; and
a control unit which controls the image forming apparatus to enter the trial printing mode when the judgment unit judges that the image read by the image reading device is outside an image formation region of the paper to be printed by the printing unit.

2. The image forming apparatus according to claim 1, wherein the judgment unit counts dots other than white dots in each of lines extending in a main scanning direction and positioned side by side in a subscanning direction in a region outside the image formation region of paper to be printed by the printing unit among images read by the image reading device, and, when there is a region where a number of the counted dots exceeds a predetermined value, the judgment unit judges that the image is outside the image formation region of the paper.

3. The image forming apparatus according to claim 1, further comprising:
an image processing unit which performs image processing of the image read by the image reading device, wherein
the control unit controls the image forming apparatus to enter the trial printing mode when the judgment unit judges that the image subjected to the image processing by the image processing unit is outside the image formation region of the paper to be printed by the printing unit.

4. The image forming apparatus according to claim 1, wherein
the judgment unit judges whether or not an end portion of the image read by the image reading device inclines, and then
when the judgment unit judges that the end portion of the image read by the image reading device inclines, the control unit controls the image forming apparatus to enter the trial printing mode.

5. An image forming apparatus having a trial printing mode in which, when printing of a plurality of sheets of an image of a read document is requested, one sheet is printed first, the printing is interrupted once, and then remaining sheets are printed after the interruption of the printing is released, the image forming apparatus comprising:
an image reading device which reads an image of a document;
a printing unit which prints an image on paper based on an image read by the image reading device;
a judgment unit which judges whether or not an end portion of the image read by the image reading device inclines; and
a control unit which controls the image forming apparatus to enter the trial printing mode when the judgment unit judges that the end portion of the image read by the image reading device inclines.

6. The image forming apparatus according to claim 5, wherein the judgment unit detects a plurality of coordinate positions of changing points at which color changes from white to black with respect to the end portion of the image read by the image reading device, and then, when a difference between adjacent coordinate positions in a subscanning direction among the plurality of detected coordinates positions exceeds a certain value, the judgment unit judges that the end portion of the image inclines.

7. The image forming apparatus according to claim 5, wherein
the image reading device includes a document feeding device which feeds a document to a reading unit which reads an image, and
when the judgment unit detects that a document is fed in an inclined when the document feeding device feeds the document, the judgment unit judges that the end portion of the image inclines.
